(19) United States
(12) Patent Application Publication
(10) Pub. No.: US 2006/0248905 A1
(43) Pub. Date: Nov. 9, 2006

(54) Refrigerator and method of controlling the same

(75) Inventors: Sung Ho Cho, Gwangju-City (KR); Dae Seong Kim, Gwangju-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/331,052

(22) Filed: Jan. 13, 2006

(30) Foreign Application Priority Data
May 3, 2005 (KR) 10-2005-0037203

(51) Int. Cl. G05D 23/32; F25B 1/10

(52) U.S. Cl. 62/157; 62/510

(57) ABSTRACT

A refrigerator including a plurality of storage chambers, a valve including at least one inlet port and a plurality of outlet ports to supply refrigerant to the storage chambers, respectively, and a control unit to control the valve such that only one of the outlet ports is constantly opened when the refrigerant is supplied to at least two of the storage chambers.

### CROSS-REFERENCE TO RELATED APPLICATIONS

This application claims the benefit of Korean Patent Application No. 10-2005-0037203, filed on May 3, 2005 in the Korean Intellectual Property Office, the disclosure of which is incorporated herein by reference.

### BACKGROUND OF THE INVENTION

1. Field of the Invention

The present invention relates to a refrigerator and a method of controlling the same, and, more particularly, to a refrigerator having a valve that is capable of rotating a rotary valve plate using a stepping motor to open or close an outlet port, thereby controlling supply/interruption of fluid, and a method of controlling the same.

2. Description of the Related Art

Generally, a refrigerator is an apparatus to keep goods fresh for a long period of time. To this end, the temperatures of storage chambers of the refrigerator are kept at appropriate temperatures at which the goods are kept fresh. Some refrigerators, having two storage chambers or more, control a refrigerant cycle to satisfy different cooling conditions required for the respective storage chambers. Such refrigerators include a refrigerant channel control valve to control the refrigerant cycle such that different cooling conditions required for the respective storage chambers are satisfied.

The conventional channel control valve mainly includes a two-way valve or a three-way valve. For example, three two-way valves or two three-way valves are installed to smoothly control the cooling cycle of a refrigerator having three storage chambers. When the three two-way valves are installed, however, installation space for the valves is increased, and the construction of a control device to control the three two-way valves is complicated. When the two three-way valves are installed, on the other hand, all of the inlet and outlet ports of the three-way valves are not used, and therefore, resources are wasted and the installation structure is complicated.

Furthermore, the conventional channel control valve has a large number of opening/closing combinations of the inlet and outlet ports. As a result, control operations of a stepping motor are increased, and therefore, the control algorithm is complicated. In addition, time necessary to examine the normal operation (for example, water leakage) at the respective opening/closing combinations of the valve is greatly increased. For example, the number of the opening/closing combinations of a valve having n outlet ports is 2n. Consequently, as the number of the outlet ports is increased, the number of opening/closing combinations is also increased, and therefore, as the number of the outlet ports is increased, time necessary to examine the normal operation is also increased.

In addition, when the outlet ports are simultaneously opened, and therefore, fluid is supplied to the respective loads in the system using the conventional channel control valve under the condition that there is a difference in magnitude of resistance at the load sides (for example, length or sectional area of a refrigerant pipe, through which the refrigerant is supplied), to which fluid is supplied through the respective outlet ports, unbalance in the amount of refrigerant supplied to the loads due to the difference in magnitude of resistance at the load sides is caused. If a large amount of refrigerant is supplied to an evaporator, to which a small amount of refrigerant is to be supplied, and if a small amount of refrigerant is supplied to another evaporator, to which a large amount of refrigerant is to be supplied, unbalance of refrigerant supply is caused. Especially in the system that indirectly determines the amount of supplied refrigerant based on refrigerant supply time, the amount of supplied refrigerant is not accurately detected due to unbalance of refrigerant supply, and therefore, accurate control of the temperature of the respective storage chambers is not accomplished.

### SUMMARY OF THE INVENTION

Therefore, it is an aspect of the invention to provide a refrigerator and a method of controlling the same that is capable of reducing time necessary to develop and produce products and of accurately controlling flow rate of fluid.

In accordance with one aspect, the present invention provides a refrigerator including: a plurality of storage chambers; a valve including at least one inlet port and a plurality of outlet ports to supply refrigerant to the storage chambers, respectively; and a control unit to control the valve such that only one of the outlet ports is constantly opened when the refrigerant is supplied to at least two of the storage chambers.

The valve may be a stepping motor valve further including a stepping motor having a plurality of control operations to supply the refrigerant to the storage chambers, the stepping motor being operated to constantly open only one of the outlet ports at the respective control operations.

The control unit may control at least two of the outlet ports to be alternately opened/closed to supply the refrigerant to at least two of the storage chambers such that the refrigerant is alternately supplied to the at least two storage chambers.

When the at least two outlet ports are alternately opened/closed, the opening time of at least one of the at least two outlet ports is different from that of the remaining outlet port.

In accordance with another aspect, the present invention provides a refrigerator including: a plurality of storage chambers; a valve including at least one inlet port and a plurality of outlet ports to supply refrigerant to the storage chambers, respectively; and a control unit to control the valve such that only one of the outlet ports is constantly opened when the refrigerant is supplied to the storage chambers, where the control unit controls at least two of the outlet ports not to be simultaneously opened but to be alternately opened/closed to supply the refrigerant to at least two of the storage chambers such that the refrigerant is supplied to the at least two storage chambers.

The valve may be a stepping motor valve further including a stepping motor having a plurality of control operations to supply the refrigerant to the storage chambers, the stepping motor being operated to constantly open only one of the outlet ports at the respective control operations.

The control unit may variably control alternating opening/closing time of the at least two outlet ports to adjust the amount of refrigerant supplied through the at least two outlet ports according to the amount necessary to cool the respective storage chambers.

The storage chambers may include first to third storage chambers; the outlet ports of the valve include first to third outlet ports to supply refrigerant to the first to third storage chambers, respectively; the refrigerator has first to third control operations to open only one of the outlet ports; the first outlet port is opened and the second and third outlet ports are closed at the first control operation, the second outlet port is opened and the first and third outlet ports are closed at the second control operation, and the third outlet port is opened and the first and second outlet ports are closed at the third control operation; and the corresponding ones of the first to third control operations to open the corresponding one of the at least two outlet ports are alternately controlled, when cooling at least two of the storage chambers, to cool the corresponding storage chambers.

In accordance with another aspect, the present invention provides a refrigerator including: first to third storage chambers; a valve including at least one inlet port and first to third outlet ports to supply refrigerant to the first to third storage chambers, respectively; and first to fourth control operations to open only one of the outlet ports, where the first outlet port is opened and the second and third outlet ports are closed at the first control operation, the second outlet port is opened and the first and third outlet ports are closed at the second control operation, the third outlet port is opened and the first and second outlet ports are closed at the third control operation, and the first outlet port is opened and the second and third outlet ports are closed at the fourth control operation.

The fourth operation is a control operation to alternately open/close the first and third outlet ports together with the third operation such that the refrigerant is supplied to the first and third storage chambers while the second outlet port is not opened.

When the number of the storage chambers is 4 or more, the number of the control operations is increased to alternately control at least two control operations which are not adjacent to each other.

In accordance with yet another aspect, the present invention provides a method of controlling a refrigerator including: a plurality of storage chambers; and a valve including at least one inlet port and a plurality of outlet ports to supply refrigerant to the storage chambers, respectively, wherein the method includes: controlling the valve such that only one of the outlet ports is constantly opened when the refrigerant is supplied to at least two of the storage chambers.

The method may further include: controlling at least two of the outlet ports to be alternately opened/closed to supply the refrigerant to at least two of the storage chambers such that the refrigerant is alternately supplied to the at least two storage chambers.

When the at least two outlet ports are alternately opened/closed, the opening time of at least one of the at least two outlet ports is different from that of the remaining outlet port.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a view showing a control system of a refrigerator according to an embodiment of the present invention;

FIG. 2 is a view illustrating control operations of a stepping motor of a four-way motorized valve according to an embodiment of the present invention;

FIG. 3 is a view illustrating the comparison between opening/closing combinations of a conventional four-way motorized valve and the control operations of the stepping motor according to the present invention illustrated in FIG. 2;

FIG. 4 is a view illustrating a method of controlling the four-way motorized valve according to the embodiment of the present invention to supply refrigerant to first and second storage chambers;

FIG. 5 is a view illustrating a method of controlling the four-way motorized valve according to the embodiment of the present invention to supply refrigerant to first and third storage chambers;

FIG. 6 is a view illustrating a method of controlling the four-way motorized valve according to the embodiment of the present invention to supply refrigerant to second and third storage chambers;

FIG. 7 is a view illustrating a method of controlling the four-way motorized valve according to the embodiment of the present invention to supply refrigerant to first to third storage chambers; and

FIG. 8 is a view illustrating a method of controlling the four-way motorized valve according to the embodiment of the present invention to supply refrigerant to first to third storage chambers and then to stop supply of the refrigerant to one of the storage chambers while allowing the refrigerant to be supplied to the remaining storage chambers.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

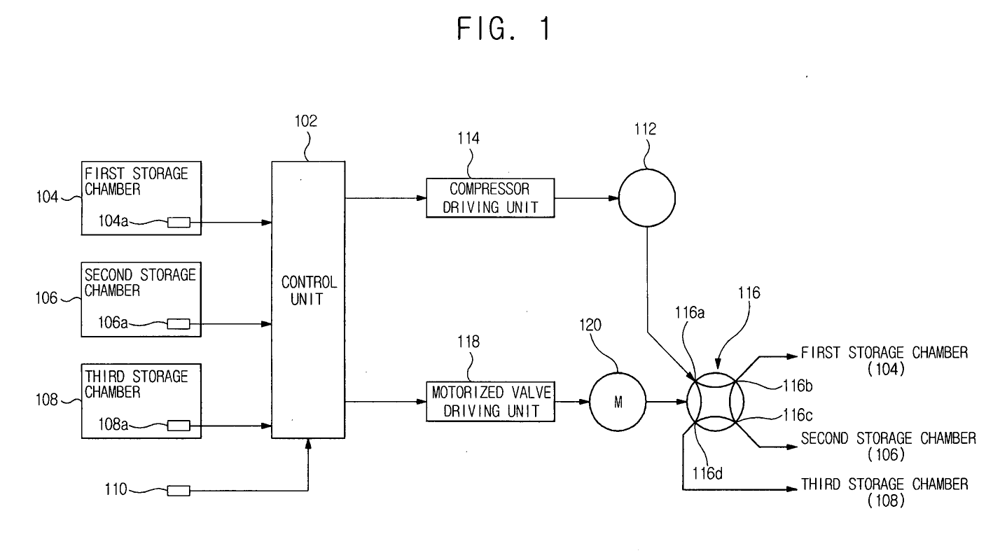

FIG. 1 is a view showing a control system of a refrigerator according to an embodiment of the present invention. As shown in FIG. 1, first to third storage chamber temperature sensors 104a, 106a, and 108a and an external temperature sensor 110 are electrically connected to the input side of a control unit 102 to control the operation of the refrigerator. The first to third storage chamber temperature sensors 104a, 106a, and 108a detect the interior temperatures of first to third storage chambers 104,106, and 108, generate electric signals having magnitudes corresponding to the detected temperatures, and transmit the generated electric signals to the control unit 102. The external temperature sensor 110 detects the temperature outside the refrigerator (for example, the temperature of a space where the refrigerator is installed), generates an electric signal having a magnitude corresponding to the detected temperature, and transmits the generated electric signal to the control unit 102. To the output side of the control unit 102 are electrically connected a compressor driving unit 114 to drive a compressor 112 and a motorized valve driving unit 118 to drive a four-way motorized valve 116. The control unit 102 controls the compressor 112 and the four-way motorized valve 116, based on temperature information detected by the first to third storage chamber temperature sensors 104a, 106a, and 108a, such that the interior temperatures of the first to third storage chambers 104, 106, and 108 follow target temperatures, respectively.

The four-way motorized valve 116 according to an embodiment of the present invention shown in FIG.1 is a stepping motor valve that is driven by a stepping motor 120. The four-way motorized valve 116 has one inlet port 116a and three outlet ports 116b, 116c, and 116d. The first to third outlet ports 116b, 116c, and 116d are opened/closed, according to control operations of the stepping motor 120 (i.e., specific rotation angles at which the respective outlet ports are opened), to allow or interrupt supply of refrigerant to the first to third storage chambers 104, 106, and 108, respectively.

In the four-way motorized valve 116, only one of the first to third outlet ports 116b, 116c, and 116d is opened. In other words, two outlet ports or more are not simultaneously opened. When refrigerant is to be supplied to two storage chambers or more, the outlet ports corresponding to the storage chambers are alternately opened. Consequently, the refrigerant is alternately supplied to two storage chambers or more (in fact, to evaporators of the storage chambers) although only one outlet port is opened. Furthermore, the number of control operations of the stepping motor to control opening/closing of the outlet ports 116b, 116c, and 116d is greatly reduced as compared to the conventional art although the four-way motorized valve 116 is configured such that only one outlet port is opened.

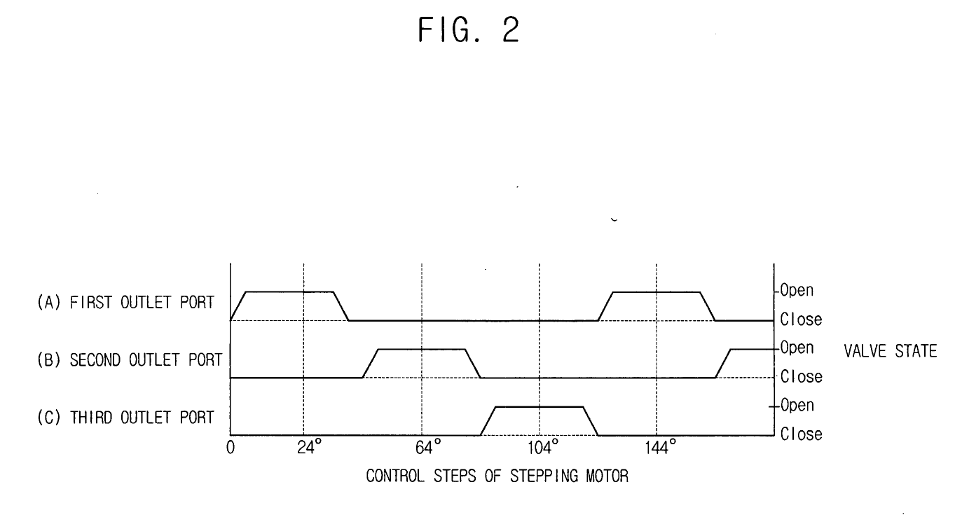

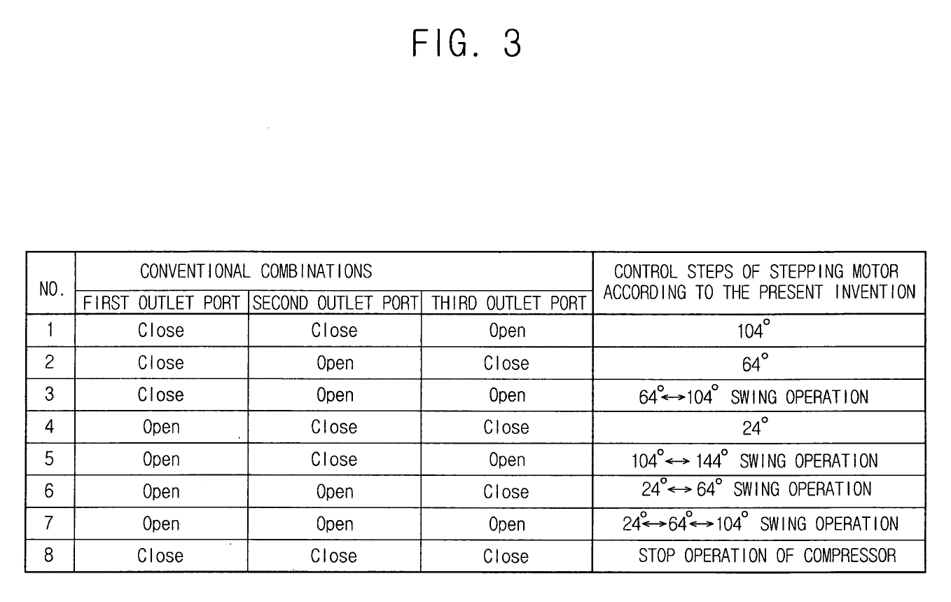

FIG. 2 is a view illustrating control operations of the stepping motor of the four-way motorized valve according to an embodiment of the present invention, and FIG. 3 is a view illustrating the comparison between opening/closing combinations of a conventional four-way motorized valve and the control operations of the stepping motor 120 according to the present invention illustrated in FIG. 2. As shown in FIG. 2, the stepping motor 120 of the four-way motorized valve 116 according to the embodiment of the present invention has only four control operations, which are 24°, 64°, 104°, and 144°. At the first control operation (24°), only the first outlet port 116b is opened. At the second control operation (64°), only the second outlet port 116c is opened. At the third control operation (104°), only the third outlet port 116d is opened. At the fourth control operation (144°), only the first outlet port 116b is opened.

Supply of refrigerant to one of the first to third storage chambers 104, 106, and 108 is sufficiently accomplished by individual opening of the first to third outlet ports through the first to third control operations (24°, 64°, and 104°) illustrated in FIG. 2. When the refrigerant is to be simultaneously supplied to two storage chambers or more, on the other hand, swing operations are performed to periodically reciprocate between the control operations to open the respective outlet ports corresponding to the storage chambers, which provides effects corresponding to simultaneous opening of two outlet ports or more in the conventional art.

As illustrated in FIG. 3, eight control operations of the stepping motor 120 are required to accomplish eight opening/closing combinations in the conventional art. According to the present invention, on the other hand, opening/closing corresponding to the conventional eight opening/closing combinations, are accomplished by the four control operations (24°, 64°, 104°, and 144°) of the four-way motorized valve 116 and stopping the operation of the compressor.

In FIG. 3, first, second, and fourth combinations of the eight opening/closing combinations correspond to the third, second, and first control operations (104°, 64°, and 24°) of the stepping motor according to the present invention, respectively. In FIG. 3, third, fifth, sixth, and seventh combinations are used to simultaneously supply refrigerant to two storage chambers or more. In this case, swing operations are performed between the adjacent two control operations or more among the control operations of FIG. 2 to accomplish the same opening/closing as the simultaneous opening of two outlet ports or more in the conventional art.

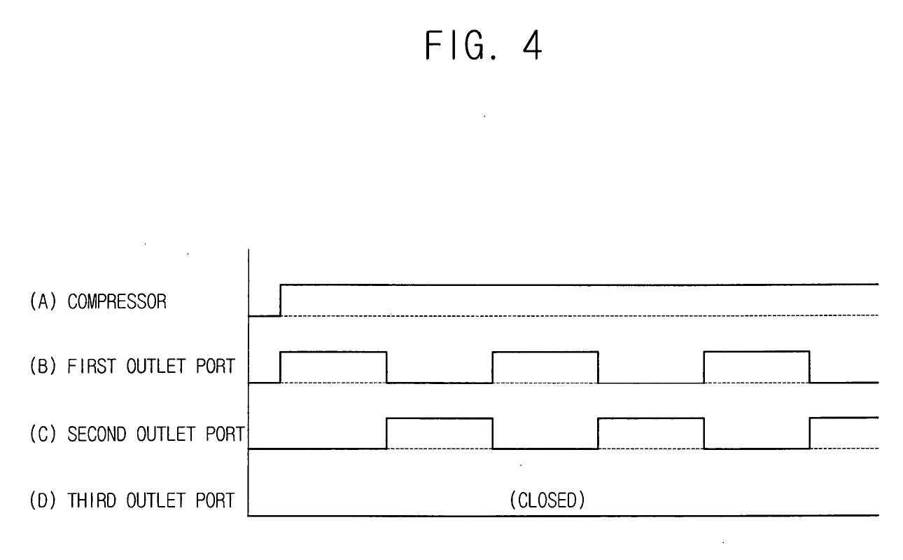

FIG. 4 is a view illustrating a method of controlling the four-way motorized valve 116 according to an embodiment of the present invention to supply refrigerant to the first and second storage chambers 104 and 106 (see the sixth combination of FIG. 3). As illustrated in FIG. 4, the first outlet port 116b and the second outlet port 116c are alternately opened/closed, while the compressor 112 is operated, such that the refrigerant is supplied to the first and second storage chambers 104 and 106 in the state that the first outlet port 116b and the second outlet port 116c are not simultaneously opened but only one outlet port is opened at a time. In this case, the stepping motor 120 performs the swing operation between the first control operation (24°) and the second control operation (64°) of FIG. 2. However, supply of the refrigerant to the third storage chamber 108 is unnecessary, and therefore, the third outlet port 116d is closed.

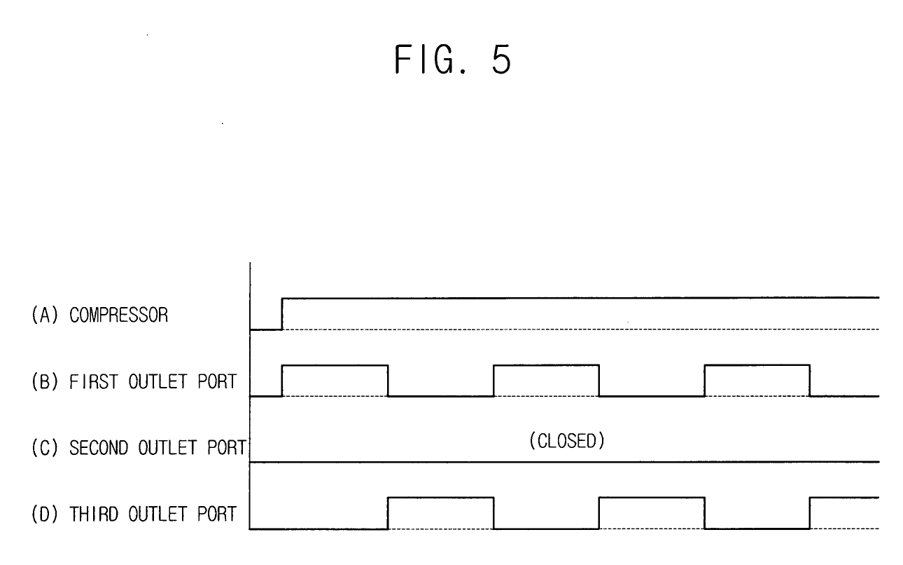

FIG. 5 is a view illustrating a method of controlling the four-way motorized valve 116 according to the embodiment of the present invention to supply refrigerant to the first and third storage chambers 104 and 108 (see the fifth combination of FIG. 3). As illustrated in FIG. 5, the first outlet port 116b and the third outlet port 116d are alternately opened/closed, while the compressor 112 is operated, such that the refrigerant is supplied to the first and third storage chambers 104 and 108 in the state that the first outlet port 116b and the third outlet port 116d are not simultaneously opened but only one outlet port is opened. At this time, supply of the refrigerant to the second storage chamber 106 is unnecessary, and therefore, the second outlet port 116c is closed. When the stepping motor 120 is controlled to perform the swing operation between the first control operation (24°) and the third control operation (104°) of FIG. 2, however, the second outlet port 116c may be opened, since the second control operation (64°) is present on the swing route of the stepping motor 120, and therefore, the refrigerant may be supplied to the second storage chamber 106. For this reason, the stepping motor is controlled to perform the swing operation not between the first control operation (24°) and the third control operation (104°) but between the fourth control operation (144°) and the third control operation (104°) such that only the first and third outlet ports 116b and 116d are alternately opened/closed.

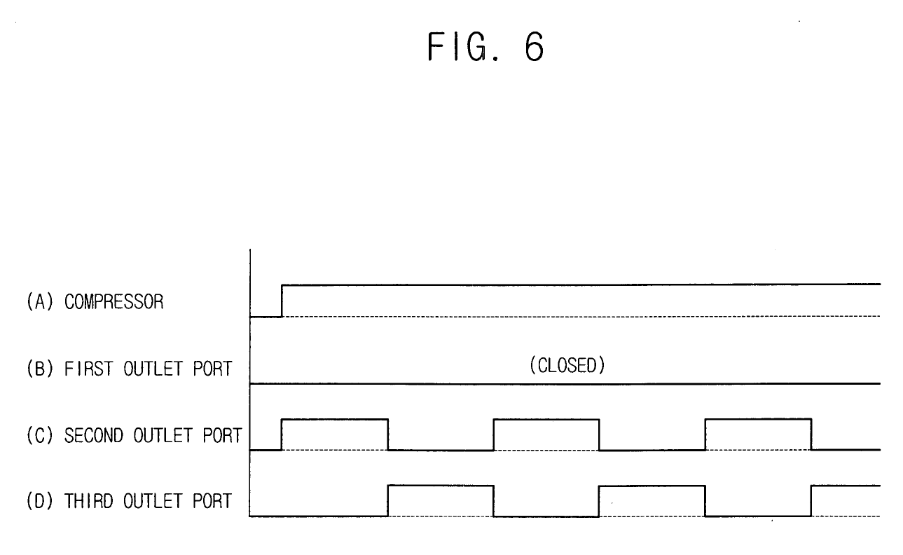

FIG. 6 is a view illustrating a method of controlling the four-way motorized valve 116 according to an embodiment of the present invention to supply refrigerant to the second and third storage chambers 106 and 108 (see the third combination of FIG. 3). As illustrated in FIG. 6, the second outlet port 116c and the third outlet port 116d are alternately opened/closed, while the compressor 112 is operated, such that the refrigerant is supplied to the second and third storage chambers 106 and 108 in the state that the second outlet port 116c and the third outlet port 116d are not simultaneously opened but only one outlet port is opened. In this case, the stepping motor 120 performs the swing operation between the second control operation (64°) and the third control operation (104°). At this time, supply of the refrigerant to the first storage chamber 104 is unnecessary, and therefore, the first outlet port 116b is closed.

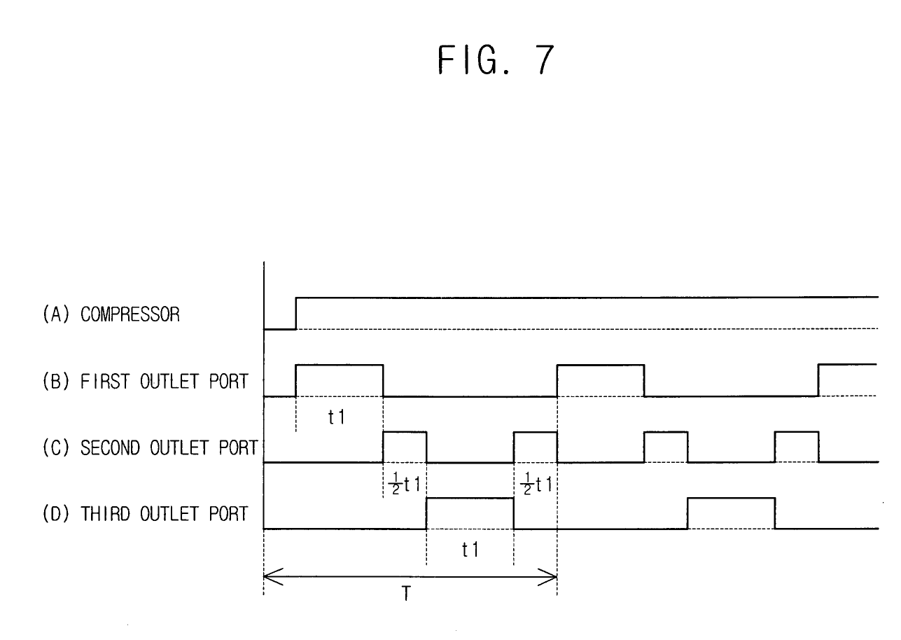

FIG. 7 is a view illustrating a method of controlling the four-way motorized valve 116 according to an embodiment of the present invention to supply refrigerant to the first to third storage chambers 104, 106, and 108 (see the seventh combination of FIG. 3). As illustrated in FIG. 7, the first to third outlet ports 116b, 116c, and 116d are alternately opened/closed, while the compressor 112 is operated, such that the refrigerant is supplied to the first to third storage chambers 104, 106, and 108 in the state that the first to third outlet ports 116b, 116c, and 116d are not simultaneously opened but only one outlet port is opened.

In this case, the stepping motor 120 performs the swing operation between the first control operation (24°), the second control operation (64°), and the third control operation (104°). However, the motorized valve, the inlet and outlet ports of which are opened or closed by the stepping motor 120, has a stopper to establish a reference point (0°) of the control operations (angles) of the stepping motor 120, and the stepping motor 120 cannot be rotated more than one rotation in one direction by the stopper (generally, the rotation of the stepping motor is limited to within 180°). Due to the limitation of rotation of the stepping motor, the control operations of the stepping motor must be controlled in the order of 24°→64°→104°→64°→24° to supply the refrigerant to the first to third storage chambers 104, 106, and 108, as shown in FIG. 7. Specifically, the first to third outlet ports 116b, 116c, and 116d must be opened in the order of 116b→116c→116d→116c→116b. At this time, the second outlet port 116c is opened twice although the first and third outlet ports 116b and 116d are opened once for one cycle T of the control operations of the stepping motor of FIG. 7. Consequently, when the same amount of refrigerant is to be supplied to the first to third storage chambers 104, 106, and 108, as shown in FIG. 7, the first and third outlet ports 116b and 116d are controlled to be opened for a first set time t1, the second outlet port 116c is controlled to be opened for half the first set time t1, i.e., ½ t1, whenever the second outlet port 116c is opened such that the second outlet port 116c is opened twice for ½ t1. As a result, the total opening time of the second outlet port 116c is equal to the opening time of the respective first and third outlet ports 116b and 116d, and therefore, the amount of refrigerant supplied through the first to third outlet ports 116b, 116c, and 116d is the same.

When the refrigerant is to be supplied to two storage chambers or more using the method of FIG. 7, the outlet ports corresponding to the storage chambers are alternately opened while changing the opening time of the respective outlet ports such that desired amount of refrigerant is supplied to the respective storage chambers. Specifically, when a large amount of refrigerant is to be supplied, the corresponding outlet port is opened for a relatively long period of time. When a small amount of refrigerant is to be supplied, on the other hand, the corresponding outlet port is opened for a relatively short period of time. In this way, the amount of refrigerant supplied to the storage chambers 104, 106, and 108 is controlled by controlling the opening time of the respective outlet ports 116b, 116c, and 116d. Consequently, unbalance in amount of refrigerant supplied to the loads due to a difference in magnitude of resistance at the load sides when the refrigerant is supplied to two storage chambers or more is effectively prevented.

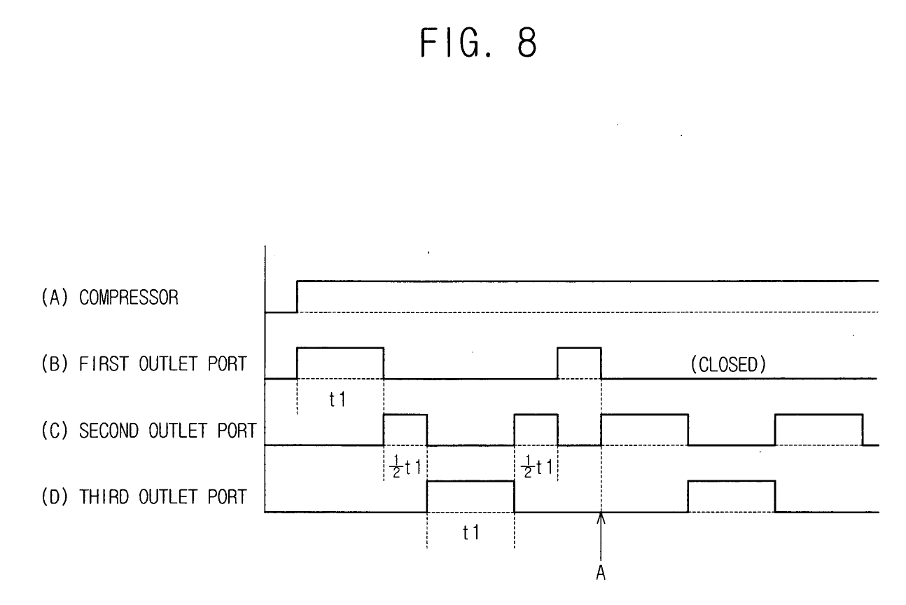

FIG. 8 is a view illustrating a method of controlling the four-way motorized valve 116 according to an embodiment of the present invention to supply refrigerant to the first to third storage chambers 104, 106, and 108 and then to stop supply of the refrigerant to one of the storage chambers while allowing the refrigerant to be supplied to the remaining storage chambers. If the temperature of the first storage chamber 104 reaches the target temperature (time point A of FIG. 8) while the first to third outlet ports 116b, 116c, and 116d are alternately opened to supply the refrigerant to the first to third storage chambers 104, 106, and 108, as illustrated in FIG. 8, the first outlet port 116b is closed, and the second and third outlet ports 116c and 116d are alternately opened such that the refrigerant is supplied to the second and third storage chambers 106 and 108. As described above in connection to FIG. 7, the opening time of the second outlet ports 116c is controlled to be half the opening time t1 of the first and third outlet ports 116b and 116d, i.e., ½ t1, while the refrigerant is supplied to the first to third storage chambers 104, 106, and 108. After the time point A at which the refrigerant supply to the first storage chamber 104 is stopped, however, the opening time of the second and third outlet ports 106 and 108 are controlled to be equal to t1 such that the balance in amount of refrigerant supplied to the second and third storage chambers 106 and 108 is accomplished.

If the opening/closing time of the respective outlet ports 116b, 116c, and 16d is changed corresponding to the amount of refrigerant supply required for the first to third storage chambers 104, 106, and 108 using the control method of FIG. 7, an exact amount of refrigerant can be supplied to the first to third storage chambers 104, 106, and 108 based on the amount of refrigerant supply required for the first to third storage chambers 104, 106, and 108 when the cooling conditions required for the storage chambers are different, and the temperatures of the first to third storage chambers 104, 106, and 108 can be accurately controlled.

The present invention is not limited to the above-described four-way valve. For example, the present invention may be applicable to a three-way valve or a valve having five outlet ports or more (if the refrigerator has four storage chambers or more). Furthermore, the present invention is not limited to the refrigerator. For example, the present invention may be applied to all industries requiring control of flow channel or flow rate of fluid.

As apparent from the above description, all of the outlet ports of the valve are used. Consequently, surplus valves are not present, and therefore, resource waste is eliminated, and the structure is simplified.

Furthermore, the number of opening/closing combinations of the outlet ports is small, and therefore, the control operations of the stepping motor is reduced. As a result, the control algorithm is simplified, and time necessary to examine the normal operation (for example, water leakage) at the respective opening/closing combinations of the valve is greatly reduced.

In addition, the amount of fluid supplied through the respective outlet ports is accurately and uniformly controlled in the system using the valve according to the present invention although there is a difference in magnitude of resistance at the load sides (for example, length or sectional area of a refrigerant pipe, through which the refrigerant is supplied), to which fluid is supplied through the respective outlet ports. Consequently, the temperature of the storage chambers is accurately controlled in an apparatus, such as a refrigerator.

Although embodiments of the present invention has been shown and described, it would be appreciated by those skilled in the art that changes may be made in this embodiment without departing from the principles and spirit of the invention, the scope of which is defined in the claims and their equivalents.

What is claimed is:

1. A refrigerator comprising:
a plurality of storage chambers;
a valve including at least one inlet port and a plurality of outlet ports to supply refrigerant to the storage chambers, respectively; and
a control unit to control the valve such that only one of the outlet ports is constantly opened when the refrigerant is supplied to at least two of the storage chambers.

2. The refrigerator according to claim 1, wherein the valve is a stepping motor valve further including a stepping motor utilizing a plurality of control operations to supply the refrigerant to the storage chambers, the stepping motor being operated to constantly open only one of the outlet ports at the respective control operations.

3. The refrigerator according to claim 1, wherein the control unit controls at least two of the outlet ports to be alternately opened/closed to supply the refrigerant to at least two of the storage chambers such that the refrigerant is alternately supplied to the at least two storage chambers.

4. The refrigerator according to claim 3, wherein, when the at least two outlet ports are alternately opened/closed, the opening time of at least one of the at least two outlet ports is different from that of the remaining outlet port.

5. A refrigerator comprising:
a plurality of storage chambers;
a valve including at least one inlet port and a plurality of outlet ports to supply refrigerant to the storage chambers, respectively; and
a control unit to control the valve such that only one of the outlet ports is constantly opened when the refrigerant is supplied to the storage chambers,
wherein the control unit controls at least two of the outlet ports not to be simultaneously opened but to be alternately opened/closed to supply the refrigerant to at least two of the storage chambers such that the refrigerant is supplied to the at least two storage chambers.

6. The refrigerator according to claim 5, wherein the valve is a stepping motor valve further including a stepping motor utilizing a plurality of control operations to supply the refrigerant to the storage chambers, the stepping motor being operated to constantly open only one of the outlet ports at the respective control operations.

7. The refrigerator according to claim 5, wherein the control unit variably controls alternating opening/closing time of the at least two outlet ports to adjust the amount of refrigerant supplied through the at least two outlet ports according to the amount necessary to cool the respective storage chambers.

8. The refrigerator according to claim 5, wherein
the storage chambers comprise first to third storage chambers;
the outlet ports of the valve comprise first to third outlet ports to supply refrigerant to the first to third storage chambers, respectively;
the refrigerator utilizes first to third control operations to open only one of the outlet ports;
the first outlet port is opened and the second and third outlet ports are closed at the first control operation, the second outlet port is opened and the first and third outlet ports are closed at the second control operation, and the third outlet port is opened and the first and second outlet ports are closed at the third control operation; and
the corresponding ones of the first to third control operations to open the corresponding one of the at least two outlet ports are alternately controlled, when cooling at least two of the storage chambers, to cool the corresponding storage chambers.

9. A refrigerator comprising:
first to third storage chambers;
a valve including at least one inlet port and first to third outlet ports to supply refrigerant to the first to third storage chambers, respectively; and
a control unit utilizing first to fourth control operations to open only one of the outlet ports,
wherein the first outlet port is opened and the second and third outlet ports are closed at the first control operation, the second outlet port is opened and the first and third outlet ports are closed at the second control operation, the third outlet port is opened and the first and second outlet ports are closed at the third control operation, and the first outlet port is opened and the second and third outlet ports are closed at the fourth control operation.

10. The refrigerator according to claim 9, wherein the fourth operation alternately opens/closes the first and third outlet ports together with the third operation such that the refrigerant is supplied to the first and third storage chambers while the second outlet port is closed.

11. The refrigerator according to claim 10, wherein, when the number of the storage chambers is 4 or more, the number of the control operations is increased to alternately control at least two control operations which are not adjacent to each other.

12. The refrigerator according to claim 9, wherein the control unit controls a stepping motor to perform a swing operation between the first to third operations in the order of the first control operation, the second control operation, the third control operation, the second control operation, and the first control operation such that the first to third outlet ports are alternately opened/closed in order, whereby the refrigerant is supplied to the first to third storage chambers.

13. The refrigerator according to claim 9, wherein the control unit controls the at least two outlet ports to be alternately opened/closed to adjust the amount of refrigerant supplied through the at least two outlet ports according to the amount necessary to cool the respective storage chambers.

14. A method of controlling a refrigerator comprising a plurality of storage chambers and a valve including at least one inlet port and a plurality of outlet ports to supply refrigerant to the storage chambers, respectively, the method comprising:
controlling the valve such that only one of the outlet ports is opened when the refrigerant is supplied to at least two of the storage chambers.

15. The method according to claim 14, further comprising:
controlling at least two of the outlet ports to be alternately opened/closed to supply the refrigerant to at least two of the storage chambers such that the refrigerant is alternately supplied to the at least two storage chambers.

16. The method according to claim 14, wherein, when the at least two outlet ports are alternately opened/closed, the opening time of at least one of the at least two outlet ports is different from that of the remaining outlet port.
